(19) United States
(12) Patent Application Publication
(10) Pub. No.: US 2009/0323460 A1
(43) Pub. Date: Dec. 31, 2009

(54) SYSTEM AND METHOD FOR MIXING COMPONENTS USING TURBULENCE

(76) Inventor: H. Brooks HERNDON, Lawrence, KS (US)

Correspondence Address: SPENCER, FANE, BRITT & BROWNE, 1000 WALNUT STREET, SUITE 1400, KANSAS CITY, MO, 64106-2140, US

(21) Appl. No.: 12/145,935

(22) Filed: Jun. 25, 2008

(51) Int. Cl. B01F 15/02; B01F 11/00

(52) U.S. Cl. 366/108; 366/134; 366/132

(57) ABSTRACT

A system (20) and method for mixing and blending using turbulence to thoroughly and rapidly mix and blend first and second components, thereby maximizing the evenness and degree of mixing and blending while minimizing reduction in flow rate. In operation, a second component flows into a first opening (22), into a mouth of an intermediate structure (26), and out an exit opening (32) in the intermediate structure (26). A first component interacts with the second component flowing out the exit opening (32) such that turbulence is created which mixes the first and second components. The mixed first and second components flow out a second opening (24). In one application, the system (20) may be used to mix diesel fuel and water.

### FIELD OF THE INVENTION

The present invention relates to systems and methods for mixing components using turbulence. More specifically, the present invention is a system and method for using turbulence to thoroughly and rapidly mix and blend components, thereby maximizing the evenness and degree of mixing and blending while minimizing reduction in flow rate.

### BACKGROUND OF THE INVENTION

Mechanical mechanisms, both active and passive, exist for mixing and blending components. However, many of these methods have problems and limitations. Most processes require a thorough mixing and blending of components, some of which can benefit from a finer-scale and more-complete, in-stream, continuous-flow mixing. For example, it is sometimes desirable to mix fuel and water for consumption by a diesel engine. Such a mixture reduces pollutants, including oxides of nitrogen and emissions of particulates.

Other obstacles to mixing diesel fuel and water include diesel fuel and water are immiscible, i.e., will not remain homogenized for long once mixed; the presence of water corrodes most metal; and the presence of water in diesel fuel facilitates the growth of microbes which can clog fuel lines.

### SUMMARY OF THE INVENTION

The present invention overcomes the above-described and other problems and limitations by providing a system and method for mixing flowing components using turbulence created by manipulating the flows to maximize the evenness and degree of mixing while minimizing reduction in flow rate. The present invention does this by creating vortices, in one or both components, parallel to the stream at the interface between the components.

In one embodiment, in which first and second components are flowing in a generally downstream direction, the system broadly comprises at least one first opening; at least one second opening located downstream of the first opening, wherein the first opening is offset from the second opening; and an intermediate structure having a larger first end presenting a mouth, a smaller second end, and at least one exit opening located between the first and second ends, wherein the first end is positioned substantially over a downstream side of the first opening, and the second end is positioned substantially adjacent to an upstream side of the second opening, and wherein the second component flows into the first opening, into the mouth of the intermediate structure, and out the exit opening, the first component flows past the first opening and interacts with the second component flowing out the exit opening such that turbulence is created which mixes the first and second components, and the mixed first and second components flow out the second opening.

In various applications, the system may further comprise any one or more of the following features. The first component may be a fuel; the second component may be an additive, such as water. The first and second openings may be polygonal, such as hexagonal. The edges of the first and second openings may be contoured to reduce both cavitation and resistance to flow. A vane may be located in the flowpath of at least one of the first or second components for creating additional turbulation in the flow thereof. A twisted structure may be located within at least one of the first or second openings for creating additional turbulation in the flow of the component therethrough. The intermediate structure may generally taper along its length between the first end and the second end. The intermediate structure may vibrate. The exit opening may include a first end and a second end located downstream of the first end, and the first end may be offset from the second end, such that the exit opening is angled. The intermediate structure may include a mesh material presenting a plurality of exit openings. The exit opening may vibrate. The intermediate structure may be twisted along at least a portion of its length for creating additional turbulation in the flow of the second component therethrough. The system may include a sensor located downstream of the second opening and operable to sense a property of the mixed first and second flows and to provide a sensor signal indicative thereof to a control mechanism for controlling an upstream activity to optimize the sensed property. The first and second components may be diesel fuel and water, and the sensor may be operable to detect the amount of water in the mixed first and second flows. A shut-off mechanism may be included for stopping the flow of the second component before the flow of the first component is shut off. The size and distribution of the openings is adjusted to produce a Reynolds number sufficient to produce a turbulent flow. Depending on the particular application, the Reynolds number may be approximately between 2000 to 3000.

These and other features of the present invention are described in greater detail below in the section titled DETAILED DESCRIPTION OF THE INVENTION.

### BRIEF DESCRIPTION OF THE DRAWING FIGURES

The present invention is described herein with reference to the following drawing figures, which are not necessarily to scale:

FIG. 1 is a cross-sectional perspective elevation view of an embodiment of the system of the present invention;

FIG. 2 is a fragmentary perspective view of an optional helical-component of the system of claim 1;

FIG. 3 is a cross-sectional elevation view of a particular implementation of the system of FIG. 1;

FIG. 4 is a perspective view of first and second plate components of the system of FIG. 3;

FIG. 5 is a plan view of the first and second plate components of FIG. 4;

FIG. 6 is a plan view of a first set of openings in the first plate component of FIG. 4 showing the respective flows of first and second components therethrough;

FIG. 7 is a cross-sectional plan view of exemplary interaction between adjacent streams exiting the system of FIG. 3; and

FIG. 8 is a transparent perspective view of an exit opening in an intermediate component of the system.

### DETAILED DESCRIPTION OF THE INVENTION

With reference to the drawing figures, a system and method are herein described, shown, and otherwise disclosed in accordance with various embodiments, including a preferred embodiment, and implementations of the present invention. Broadly characterized, the present invention is a system and method for mixing and blending components. The present invention controls turbulence to thoroughly and rapidly mix and blend components, maximizing the evenness and degree of mixing and blending while minimizing reduction in flow rate.

More specifically, the present invention advantageously allows for maximizing the rate and intimacy of mixing continuous flow, variable proportion component streams while minimizing the flow resistance to those streams. This is accomplished by introducing turbulence at multiple scales in both the radial (across the flow) and longitudinal (with the flow) directions. The components may be substantially any components susceptible to turbulation, including fluids, gasses, and powders; compressible and incompressible components; reactants, catalysts, or additives; pure and previously mixed components; and miscible and immiscible components. If the components are immiscible, the resultant mixture may be an emulsion. Potential applications for the present invention include processing chemicals, petroleum products, foods, drugs, synthetic materials, and resins, as well as processing fuels for engines, burners, and furnaces. For example, as discussed below, one of the components may be diesel fuel and the other may be water.

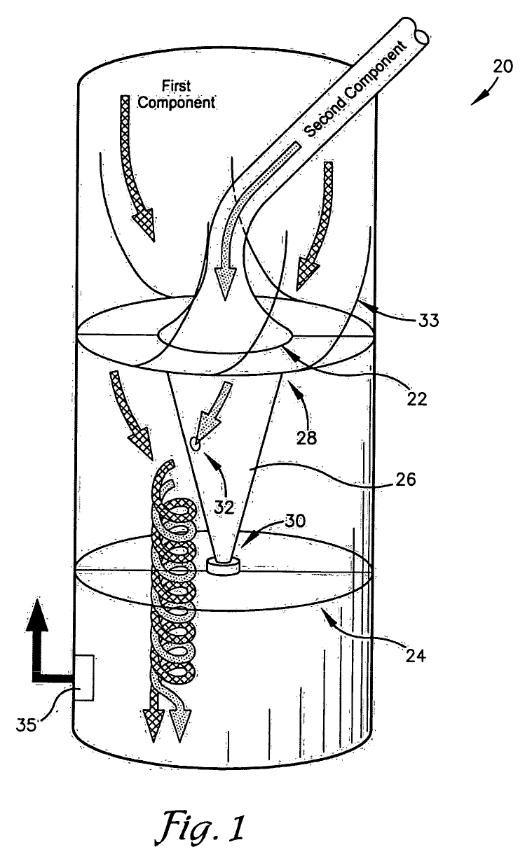

Referring to FIG. 1, the present invention creates vortices, in one or both components, parallel to the stream at the interface between the components. A first embodiment of the system 20, through which first and second components flow in a generally downstream direction, may broadly comprise at least one first opening 22; at least one second opening 24 located downstream of the first opening 22, wherein the first opening 22 is offset from the second opening 24; and an intermediate structure 26 having a larger first end 28 presenting a mouth, a smaller second end 30, and at least one exit opening 32 located between the first and second ends 28,30. The first end 28 is positioned substantially over a downstream side of the first opening 22, and the second end 30 is positioned substantially adjacent to an upstream side of the second opening 24. For at least some applications, it may be desirable that the first and second components enter the system traveling in a direction which is no more than 45 degrees removed from the direction of flow through the system, thereby minimizing directional flow resistance to the entering streams.

In operation, the second component flows into the first opening 22, into the mouth of the intermediate structure 26, and out the exit opening 32. The first component interacts with the second component flowing out the exit opening 32 such that turbulence is created which mixes the first and second components. The mixed first and second components flow out the second opening 24.

The shapes, sizes, and numbers of the openings 22,24 and exit openings 32 may depend on the particular components and application, as well as the desired performance of the system, including the desired Reynolds number, i.e., the ratio of inertial forces to viscous forces. For example, for at least some applications, at least one of the openings 22,24 may be either substantially circular or polygonal. For at least some applications, a hexagonal shape may be desirable as providing the maximum packing density and resulting in the least amount of wasted space and material. For at least one application, in which the components are diesel fuel and water, there may be at least nineteen first openings 22 arranged in three approximately concentric rings, with each first opening 22 being substantially hexagonal in shape, and at least nineteen second openings 24 arranged in three approximately concentric rings, with each second opening 24 being substantially hexagonal in shape. Depending on the particular application, the Reynolds number may be approximately between 2000 and 3000 in order to achieve sufficient turbulation.

Also, for at least some applications, it may be desirable to contour the edges or other surfaces of the first or second openings 22,24 using, e.g., an airfoil shape, in order to minimize both cavitation and resistance to flow.

The shapes, sizes, and number of the intermediate structures 26 may also depend on the particular components and application, as well as the desired performance of the system 20. In at least some applications, the intermediate structure 26 may generally taper between the first end and the second end. For example, the intermediate structure 26 may be substantially conical, frustoconical, parabolic, or hyperbolic. In at least some applications, the intermediate structure 26 may be shaped so as to draw the components in the downstream direction, including through a mutual induction effect, thereby compensating, at least to some degree, for any flow resistance introduced at other points in the system 20.

For some applications, the intermediate structure 26 may be constructed, in whole or in part, from a mesh material presenting a plurality of exit openings 32. In one implementation, the mesh material may be screen or screen-like material. In one application, the intermediate structure 26 may vibrate to further create and control turbulence. Alternatively, only the exit opening 32 may be made to vibrate to achieve substantially the same effect. For example, the intermediate structure 26, or, alternatively, only the exit opening 32, may be constructed, in whole or in part, of a metal or other material that vibrates at ultrasonic frequencies in response to an applied magnetic field or voltage.

Referring to FIG. 8, for at least some applications, the exit opening 32 may be angled or twisted relative to the surface of the intermediate structure 26 through which it passes. More specifically, the exit opening 32 may include a first end and a second end located downstream of the first end, and the first end is offset or rotated from the second end, such that the exit opening is angled or twisted between the ends.

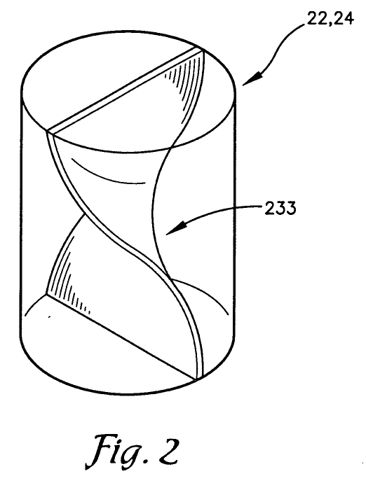

For various applications, the system 20 may further include one or more vanes 33 or other devices for manipulating the flow of one or both of the components to create additional turbulation. The vanes 33 may be located upstream of the first opening 22, between the first and second openings, 22,24, or downstream of the second opening 24. The vanes 33 may take the form of ridges machined into the walls of the conduits or manifolds through which the components flow. Referring also to FIG. 2, in other applications, the function of the vanes may be performed by spiral or otherwise twisted material 233 located within the first or second openings 22,24. For example, in an application in which the openings 22,24 are hexagonal, the material may twist through 60 degrees, i.e., through one segment of the hexagon. In still other applications, the function of the vanes may be achieved by introducing a twist in the openings 22,24 or in the intermediate structures themselves 26, so that the upstream portion of each opening 22,24 or intermediate structure 26, is rotated relative to the downstream portion.

For various applications, the system 20 may further include one or more sensors 35 located downstream of the second opening 24 and operable to sense one or more properties of the mixed first and second flows and to provide a signal indicative thereof for controlling an upstream activity, such as the flow rates of one or both components, to optimize the sensed properties. For example, in one application, the components are diesel fuel and water, and the downstream sensor 35 is operable to detect the amount of water in the mixed first and second flows and to provide a sensor signal indicative thereof for controlling the flow of water to optimize the detected amount.

For various applications, a plurality of the systems 20, or portions thereof, may be arranged in series to further mix the components. For example, a third opening may be located downstream of the second opening 24 and structurally and functionally related thereto in substantially the same manner as the first opening 22 is related to the second opening 24, including a second intermediate structure extending between the second opening 24 and a point that is adjacent to an upstream side of the third opening.

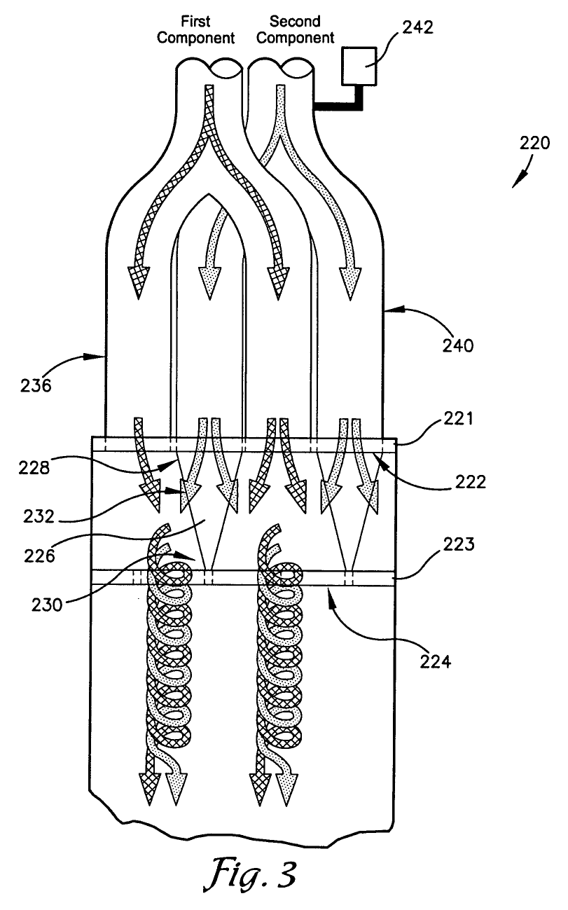

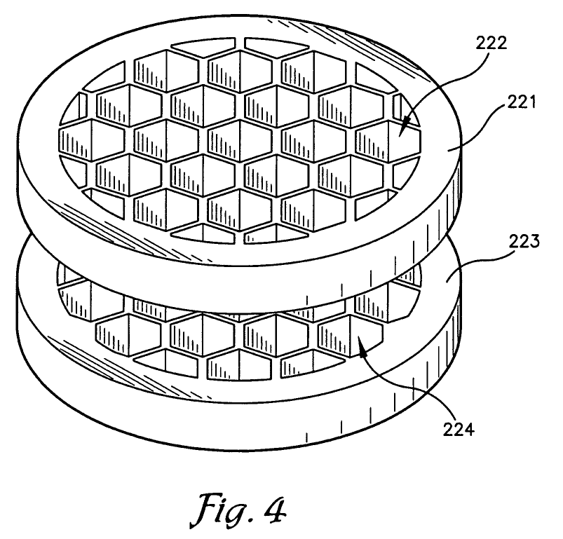

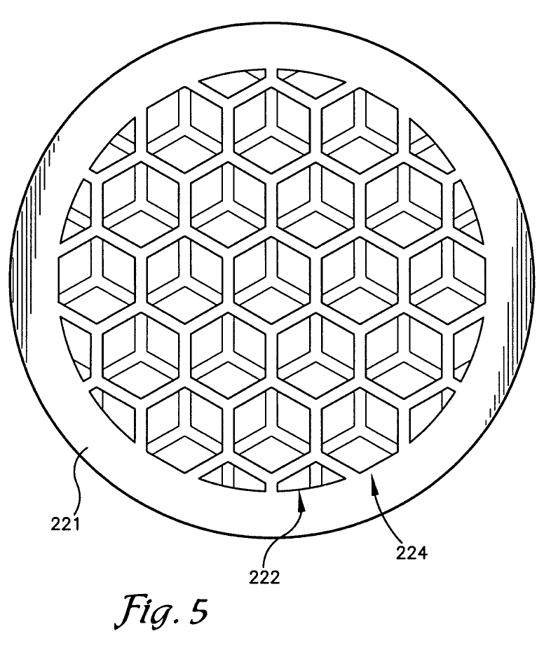

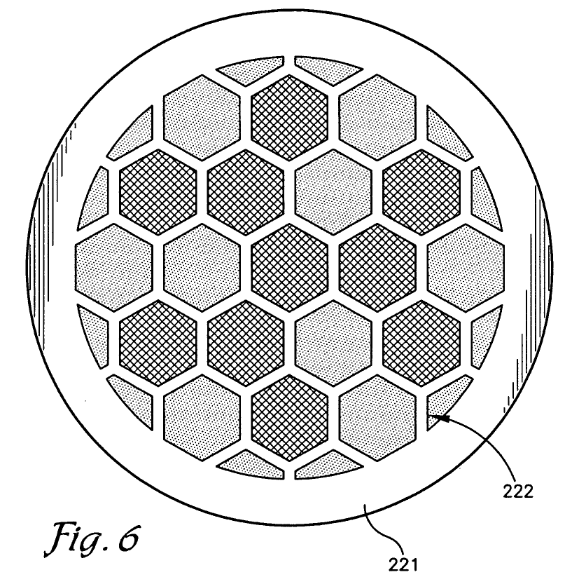

Referring also to FIGS. 3-6, in a particular application of the present invention, in which first and second components flow in a generally downstream direction through the system 220, an implementation of the system 220 may broadly comprise a first plate 221 presenting a plurality of first polygonal openings 222; a second plate 223 presenting a plurality of second polygonal openings 224, wherein the second plate 223 is located downstream of the first plate 221 and at least some of the first polygonal openings 222 are offset from at least some of the second polygonal openings 224; a plurality of intermediate structures 226, each having a larger first end 228 presenting a mouth, a smaller second end 230, and a plurality of exit openings 232 located between the first and second ends 228,230, wherein each intermediate structure 226 is positioned such that the first end 228 is positioned substantially over a downstream side of a respective one of the first polygonal openings 222, and the second end 230 is positioned substantially adjacent to an upstream side of a respective one of the second polygonal openings 224; a first reservoir containing the first component, and one or more first conduits 236 for directing the flowing first component from the first reservoir into a first portion of the first polygonal openings 222 (as shown in FIG. 6), into the mouths of the respective intermediate structures 226, and out the respective exit openings 232; and a second reservoir containing the second component, and one or more second conduits 240 for directing the flowing second component from the second reservoir into a second portion of the first polygonal openings 222 (as shown in FIG. 6), into the mouths of the respective intermediate structures 226, and out the respective exit openings 232.

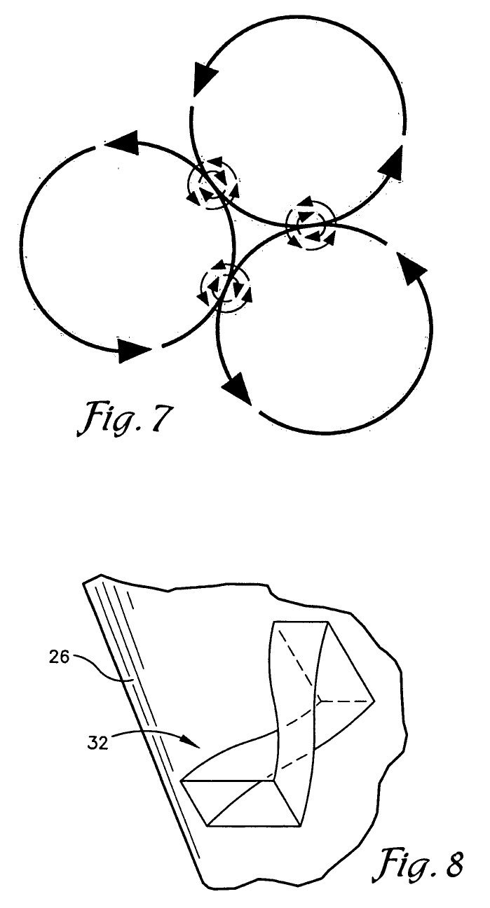

In operation, the first component flows past the exit openings 232 of the intermediate structures 226 associated with the second portion of the first polygonal openings 222 such that turbulence is created which mixes the first and second components, the second component flows past the exit openings 232 of the intermediate structures 226 associated with the first portion of the first polygonal openings 222 such that turbulence is created which mixes the first and second components, and the mixed first and second components flow out the second polygonal openings 224. After exiting the second openings 224, the components may continue to mix as adjacent streams interact with, e.g., shear against, each other, as seen in FIG. 7.

In addition to those expressly included, any one or more of the additional features discussed in association with the first embodiment of the present invention may be incorporated into or otherwise used with this particular implementation of the system 220 for this particular application.

The implementation of FIG. 3 may be used to mix, e.g., diesel fuel and water, such as in a ratio of approximately 60% diesel fuel and 40% water, for consumption by an engine. As discussed, such a mixture can reduce pollutants emitted by the engine, including oxides of nitrogen (NOx) and emissions of particulates.

When mixing diesel fuel and water, relatively fine scale mixing is desired. The scale of mixing is, at least in part, a function of the number of vertices among the sets of first and second polygonal openings 222,224. As such, the implementation of FIG. 3 may incorporate the particular aforementioned features of there being at least three approximately concentric rings. This can be accomplished, for example, with nineteen first openings 222 arranged in three concentric rows of one, six, and twelve openings, respectively. Ten of the openings may be devoted to the first component, and nine of the openings may be devoted to the second component. Similarly, there may be nineteen second openings 224 arranged in three approximately concentric rings. Each of the first and second openings 222,224 may be substantially hexagonal in shape. The intermediate structures 226 may generally taper between the first end 228 and the second end 230, and may be constructed, at least in part, from a mesh material presenting a plurality of the exit openings 232. The downstream sensor 35, if included, may be operable to detect the amount of water in the mixed first and second flows and to provide a sensor signal indicative thereof for controlling the flow of water to optimize the detected amount.

The implementation of FIG. 3 may further incorporate a shut-off mechanism 242 for stopping the flow of water before stopping the engine, thereby ensuring that substantially no water remains within the system 220, apart from within the second reservoir, to rust or otherwise damage the system's or engine's componentry. Operation of the shut-off mechanism 242 may involve receiving from the downstream sensor 35 an indication that substantially no water is present in the sensed flow.

Thus, it will be appreciated that the present invention overcomes many obstacles associated with mixing components. For example, the present invention mixes at the point of application and eliminates the need to store mixtures in a state where components might separate, and it eliminates the need for premixed emulsions and potentially-polluting additives. With regard to mixing diesel fuel and water, for example, the present invention avoids the presence of unconsumed water and thereby minimizes corrosion, avoids mixing the diesel fuel and water until needed, thereby eliminating the growth of microbes and the untimely separation of the mixed components, and minimizes adverse interference with flow rates through the use of turbulence rather than mechanical mixing mechanisms.

Although the invention has been disclosed with reference to various particular embodiments and implementations, it is understood that equivalents may be employed and substitutions made herein without departing from the scope of the invention as recited in the claims.

Having thus described the preferred embodiment of the invention, what is claimed as new and desired to be protected by Letters Patent includes the following:

1. A system for mixing first and second components using turbulence, wherein the first and second components are flowing in a generally downstream direction, the system comprising:
at least one first opening;
at least one second opening located downstream of the first opening, wherein the first opening is offset from the second opening; and
an intermediate structure having a larger first end presenting a mouth, a smaller second end, and at least one exit opening located between the first and second ends, wherein
the first end is positioned substantially over a downstream side of the first opening, and
the second end is positioned substantially adjacent to an upstream side of the second opening,
wherein the second component flows into the first opening, into the mouth of the intermediate structure and out the exit opening, the first component flows past the first opening and interacts with the second component flowing out the exit opening such that turbulence is created which mixes the first and second components, and the mixed first and second components flow out the second opening.

2. The system as set forth in claim 1, wherein the first component is a fuel.

3. The system as set forth in claim 1, wherein the second component is an additive.

4. The system as set forth in claim 3, wherein the additive is water.

5. The system as set forth in claim 1, wherein the first and second openings are polygonal.

6. The system as set forth in claim 5, wherein the first and second openings are hexagonal.

7. The system as set forth in claim 1, wherein the edges of the first and second openings are contoured to reduce both cavitation and resistance to flow.

8. The system as set forth in claim 1, further including a vane located in the flowpath of at least one of the first or second components for creating additional turbulation in the flow thereof.

9. The system as set forth in claim 1, further including a twisted structure located within at least one of the first or second openings for creating additional turbulation in the flow of the component therethrough.

10. The system as set forth in claim 1, wherein the intermediate structure generally tapers along its length between the first end and the second end.

11. The system as set forth in claim 1, wherein the intermediate structure vibrates.

12. The system as set forth in claim 1, wherein the exit opening includes a first end and a second end located downstream of the first end, and the first end is offset from the second end, such that the exit opening is angled.

13. The system as set forth in claim 1, wherein the intermediate structure includes a mesh material presenting a plurality of exit openings.

14. The system as set forth in claim 1, wherein the exit opening vibrates.

15. The system as set forth in claim 1, wherein the intermediate structure is twisted along at least a portion of its length.

16. The system as set forth in claim 1, wherein the system further includes a sensor located downstream of the second opening and operable to sense a property of the mixed first and second flows and to provide a sensor signal indicative thereof to a control mechanism for controlling an upstream activity to optimize the sensed property.

17. The system as set forth in claim 13, wherein the first and second components are diesel fuel and water, and the sensor is operable to detect the amount of water in the mixed first and second flows.

18. The system as set forth in claim 1, further including a shut-off mechanism for stopping the flow of the second component before the flow of the first component is shut off.

19. The system as set forth in claim 1, wherein the system results in a Reynolds number sufficient to produce a turbulent flow.

20. The system as set forth in claim 19, wherein the Reynolds number is approximately between 2000 to 3000.

21. A system for mixing first and second components using turbulence, wherein the components are flowing in a generally downstream direction, the system comprising:
a first plate presenting a plurality of first polygonal openings;
a second plate presenting a plurality of second polygonal openings, wherein the second plate is located downstream of the first plate and at least some of the first polygonal openings are offset from at least some of the second polygonal openings;
a plurality of intermediate structures, each intermediate structure having a larger first end presenting a mouth, a smaller second end, and a plurality of exit openings located between the first and second ends, wherein each intermediate structure is positioned such that
the first end is positioned substantially over a downstream side of a respective one of the first polygonal openings, and
the second end is positioned substantially adjacent to an upstream side of a respective one of the second polygonal openings;
one or more first conduits for directing the flowing first component from a first reservoir into a first portion of the first polygonal openings, into the mouths of the respective intermediate structures, and out the respective exit openings; and
one or more second conduits for directing the flowing second component from a second reservoir into a second portion of the second polygonal openings, into the mouths of the respective intermediate structures, and out the respective exit openings,
wherein the first component flows past the exit openings of the intermediate structures associated with the second portion of the first polygonal openings such that turbulence is created which mixes the first and second components, the second component flows past the exit openings of the intermediate structures associated with the first portion of the first polygonal openings such that turbulence is created which mixes the first and second components, and the mixed first and second components flow out the second polygonal openings.

22. A system for mixing diesel fuel and water using turbulence, wherein the diesel fuel and water are flowing in a generally downstream direction, the system comprising:
a first plate presenting at least three substantially concentric rings of hexagonal openings;
a second plate presenting at least three substantially concentric rings of hexagonal openings, wherein the second plate is located downstream of the first plate and at least some of the first hexagonal openings are offset from at least some of the second hexagonal openings;
a plurality of intermediate structures, each intermediate structure generally tapered between a larger first end presenting a mouth and a smaller second end, and each intermediate structure being at least partially constructed of a mesh presenting a plurality of exit openings located between the first and second ends, and each intermediate structure being positioned such that
the first end is positioned substantially over a downstream side of a respective one of the first hexagonal openings, and
the second end is positioned substantially adjacent to an upstream side of a respective one of the second hexagonal openings;
one or more first conduits for directing the flowing diesel fuel from a first reservoir into a first portion of the first hexagonal openings, into the mouths of the respective intermediate structures, and out the respective exit openings;
one or more second conduits for directing the flowing water from a second reservoir into a second portion of the first hexagonal openings, into the mouths of the respective intermediate structures, and out the respective exit openings,
wherein the fuel flows past the exit openings of the intermediate structures associated with the second portion of the first hexagonal openings such that turbulence is created which mixes the diesel fuel and water, the water flows past the exit openings of the intermediate structures associated with the first portion of the first hexagonal openings such that turbulence is created which mixes the diesel fuel and water components, and the mixed diesel fuel and water flow out the second hexagonal openings for consumption by an engine;
a sensor located downstream of the second hexagonal openings and operable to detect the amount of water in the mixed first and second flows and to provide a sensor signal indicative thereof to an upstream control mechanism operable to control the flow of water to optimize the detected amount; and
a shut-off mechanism operable to stop the flow of water before stopping the engine to minimize the amount of unconsumed water remaining downstream of the second reservoir.
